(19) United States
(12) Patent Application Publication
(10) Pub. No.: US 2006/0055231 A1
(43) Pub. Date: Mar. 16, 2006

(54) Trim for a wheel rim

(76) Inventor: Richard Alan Metcalfe, Manchester (GB)

Correspondence Address: EGBERT LAW OFFICES, 412 MAIN STREET, 7TH FLOOR, HOUSTON, TX, 77002, US

(21) Appl. No.: 10/517,854

(22) PCT Filed: Jun. 12, 2003
(86) PCT No.: PCT/GB03/02527

§ 371 Date: Jul. 5, 2005

(30) Foreign Application Priority Data
Jun. 14, 2002 (GB) 0213667.9

(51) Int. Cl. B60B 7/12

(52) U.S. Cl. 301/37.33

(57) ABSTRACT

A trim for a wheel rim, in particular, an alloy wheel rim for a vehicle includes an annulus with an inturned outer rim to define radial and axial faces, which can be located over and around an outer lip of the wheel rim. A plurality of grippers are spaced around the circumference of the outer rim such that the trim can be secured to the wheel rim. A resilient insert is located around the radial and axial faces, defined on the inner side of the annulus, to cushion the trim against the wheel rim.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates to a trim for a wheel rim and in particular but not exclusively, to a protective trim for an alloy wheel rim of a vehicle.

### BACKGROUND OF THE INVENTION

Alloy wheel rims for automobiles are expensive accessories which can be easily damaged if the wheel of the vehicle strikes or grazes a kerbstone or other similar obstruction. Protective wheel trims are known which can be fitted to a wheel assembly to cover the annular edge of a wheel rim. These trims may be provided solely for aesthetic reasons but some also provide some degree of protection to the edge of the wheel rim. However, many of them suffer from the disadvantage that they interfere with the fitting of the tire to the rim and some affect the sealing fit between the tire and the wheel rim. Such interference may be dangerous if the seal is in danger of being breached and as a consequence may contravene national and international standards which control the interface between automobile tires and their rims for safety reasons.

The object of the present invention is to provide a trim for a wheel rim which does not interfere with the aforesaid interface and which will provide some degree of protection for the wheel rim against impact damage.

### BRIEF SUMMARY OF THE INVENTION

According to the present invention there is provided a trim for a wheel rim comprising an annulus with an inturned outer rim to define radial and axial faces, which can be located over and around an outer lip of the wheel rim, and a plurality of grippers spaced around the circumference of the outer rim by means of which the trim can be secured to the wheel rim, and a resilient insert which is located around the radial and axial faces defined on the inner side of the annulus to cushion the trim against the wheel rim.

Preferably, the outer rim is inturned at 90° to the outer radial face of the annulus.

Preferably also, the grippers are integrally formed with the inturned outer rim of the annulus.

Preferably also, the grippers comprise tangs which can be deformed so that they bite into an axial outer face of the wheel rim to secure the trim to the wheel rim. Advantageously, each gripper is substantially rectangular or trapezoidal and defines a tang at each of its projecting corners.

Preferably also, at least six grippers are provided equidistantly spaced around the annulus.

Preferably also, the surface of the insert adapted to contact the wheel rim is coated with an adhesive to provide an additional means of securement for the trim.

Preferably also, the inner rim of the annulus is at least partially inturned.

Preferably also, the resilient insert is molded in position on the inner side of the annulus.

Preferably also, the outer surface of the insert is contoured so as to be complementary in shape to the outer lip of a wheel rim over which it is intended to be fitted.

Preferably also, the annulus is made from rolled and pressed stainless steel.

Preferably also, the insert comprises a rubber or other similarly resilient material.

### BRIEF DESCRIPTION OF THE SEVERAL VIEWS OF THE DRAWINGS

An example of the present invention will now be described by way of example with reference to the accompanying drawing, in which:

FIG. 1 is a sectional view of a trim according to the invention operatively positioned on wheel rim;

FIG. 2 is a perspective view of a section of the trim shown in FIG. I before attachment to the wheel rim; and

FIG. 3 is a schematic side view, to a reduced scale, of the trim to show the location of grippers which form an integral part thereof.

### DETAILED DESCRIPTION OF THE INVENTION

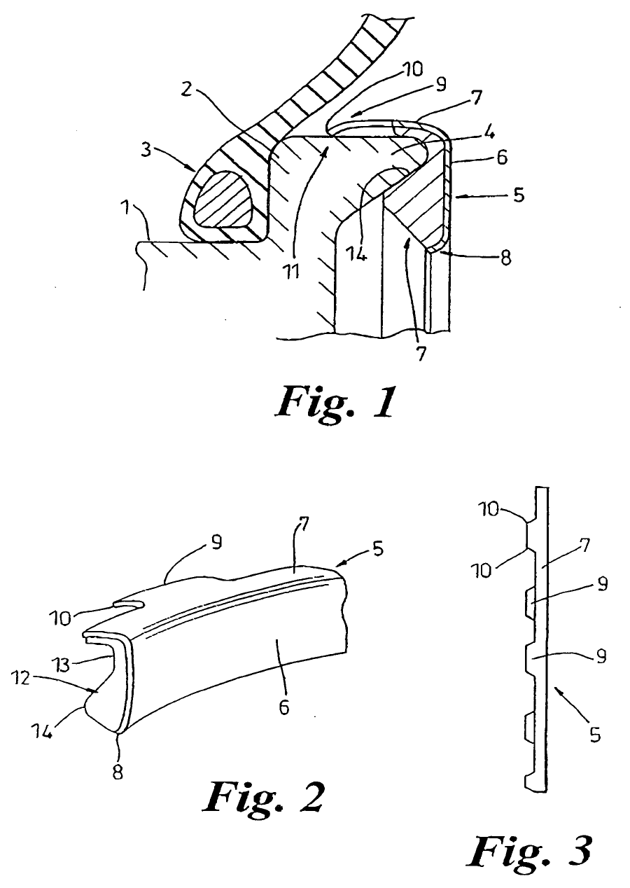

A wheel assembly of a vehicle, as shown in FIG. 1 comprises a wheel rim 1 defining an outwardly projecting flange 2. The inner side of the flange 2 thereby forms a seating to receive and seal with a tire bead 3. The outer side of the flange 2 is conventionally provided with a projecting lip 4. A trim 5 according to the present invention is adapted to be secured to the wheel rim 1 to cover and thereby provide a degree of protection for the lip 4.

The trim 5 comprises an annulus 6 which may be formed from bright rolled and pressed stainless steel or other suitable material. The annulus 6 is provided with an inturned outer rim 7, which is preferably inturned at 90° so that the annulus 6 thereby defines radial and axial faces. These faces locate over and around the projecting lip 4 of the wheel rim 1. The inner rim 8 of the annulus 6 is also at least partially inturned to provide a safe edge for handling the trim 5 and also to improve the appearance of the trim 5 when in use.

While the annulus 6 could be manufactured by being pressed from a steel sheet, it is more easily manufactured by being pressed from a steel strip and then rolled to form the annular shape with the aforementioned cross-sectional profile. The adjoining ends of the strip can then be joined together by welding using a conventional welding process such as electron beam or laser welding.

The outer rim 7 of the trim 5 provided with a plurality of grippers 9, which are integrally formed with and equidistantly spaced around the circumference of the outer rim 7 as shown in FIG. 3. Preferably, at least six grippers 9 are provided by means of which the trim can be secured to the wheel rim 1. The grippers 9 comprise curving rectangular or trapezoidal members that define tangs 10 with sharp edges at their projecting corners. By elastically deforming the grippers 9, for example by hammering around the rim in an axial direction using a soft-faced hammer, the sharp edges of the tangs 10 can be made to bite into the axial outer face 1I1 of the flange 2 of the wheel rim 1 to secure the trim 5 in position over the lip 4.

A resilient insert 12 is located around the radial and axial faces defined by the inner side of the annulus 6 in order to cushion the trim 5 against the wheel rim 1. The insert 12 preferably comprises a rubber or other similarly resilient material. While the insert 12 could be push-fitted into position into the curving interior defined by the inner side of the annulus 5, preferably it is molded in situ by injection molding or similar conventional process. As different models of automobiles and alloy wheel trims have slightly different profiles, preferably the outer surface of the insert is contoured as at 13 so as to be complementary in shape to the projecting lip 4 of the wheel rim 1 over which it is intended to be fitted. This spreads the load of any impact over a larger portion of the rim 1 and thereby provides a better cushioning effect, with actual damage to the rim 1 being less likely if the impact is only minor. The insert 12 also aids the fitting of the trim 5 to the wheel rim 1.

In order to assist in the securement of the trim 5 to the wheel rim 1, the exposed surface 14 of the insert 12 that is adapted to contact the wheel rim 1 is coated with an adhesive. The adhesive may be a rapid-curing or contact adhesive that is applied manually immediately before fitment of the trim 5 the wheel rim 1. Alternatively, the adhesive may be applied when the trim 5 is manufactured and covered by a peelable release liner (not shown) that can be peeled off to expose the adhesive immediately prior to fitment.

Fitment of the trim 5 to a vehicle wheel rim 1 is accomplished by locating the trim 5 over the projecting lip 4 of a wheel rim so that the insert 12 can adhere closely to the apposed surface of the lip 4 and the wheel rim 1 and so that at least one and preferably two grippers 9 are in close contact with the axial outer face 11 of the flange 2 of the wheel rim 1. The other grippers 9 can then be hammered into gripping contact with the face 11 by a hide-faced hammer or similar tool.

1. A trim for a wheel rim comprising:
an annulus with an inturned outer rim defining radial and axial faces thereof, the outer rim being locatable over and around an outer lip of the wheel rim;
a plurality of grippers spaced around the a circumference of the outer rim and in securing relation for the outer rim to the wheel rim; and
a resilient insert located around the radial and axial faces defined on an inner side of the annulus in cushioning relation between the outer rim against the wheel rim.

2. A trim as claimed in claim 1, wherein the outer rim is inturned at 90° to the outer radial face of the annulus.

3. A trim as claimed in claim 1, wherein the grippers are integrally formed with the inturned outer rim of the annulus.

4. A trim as claimed in claim 1, wherein the grippers comprise tangs which deformed deformable so that the tangs bite into an axial outer face of the wheel rim to secure the outer rim to the wheel rim.

5. A trim as claimed in claim 4, wherein each gripper is substantially rectangular and comprises a tang at each projecting corner thereof.

6. A trim as claimed in claim 1, wherein at least six grippers are provided equidistantly spaced around the annulus.

7. A trim as claimed in claim 1, wherein a surface of the insert adapted to contact the wheel rim is coated with an adhesive providing an additional securement for the trim for the outer to the wheel rim.

8. A trim as claimed in claim 1, wherein the inner rim of the annulus is at least partially inturned.

9. A trim as claimed in claim 1, wherein the resilient insert is molded in position on the inner side of the annulus.

10. A trim as claimed in claim 1, wherein an outer surface of the insert is contoured so as to be complementary in shape to the outer lip of a wheel rim.

11. A trim as claimed in claim 1, wherein the annulus is comprised of rolled and pressed stainless steel.

12. A trim as claimed in claim 1, wherein the insert comprises a rubber or other similarly resilient material.
